(19) United States
(12) Patent Application Publication
(10) Pub. No.: US 2008/0234848 A1
(43) Pub. Date: Sep. 25, 2008

(54) Frequency-tracked synthesizer employing selective harmonic amplification

(76) Inventor: Brian J. Kaczynski, San Francisco, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 11/728,121

(22) Filed: Mar. 23, 2007

(51) Int. Cl. G06F 17/00

(52) U.S. Cl. 700/94; 341/110

(57) ABSTRACT

This invention relates to effects processing of a monophonic analog signal, meaning a signal whose frequency components are all integer multiples of a first fundamental frequency. For example, the signal could come from almost any musical instrument, voice included. However, for generality, the invention is not restricted to cases where the signal source is musical. The digital signal processing is simplified as a result of the DSP being clocked at a constant multiple of f_{fund}. This means that the sine and cosine functions, as well as the low-pass filters which make up each harmonic selector, are trivial to implement because the frequencies of each sine/cosine, as well as the cutoff frequency of the low-pass filters, are constant fractions of the DSP clock frequency.

### BACKGROUND OF THE INVENTION

1. Field of the Invention

The present invention relates generally to the field of digital sound processing and more particularly to processing monophonic analog signals.

2. Background Art

This invention is an application of DIGITAL SIGNAL PROCESSING EMPLOYING A CLOCK FREQUENCY WHICH IS ALWAYS A CONSTANT INTEGER MULTIPLE OF THE FUNDAMENTAL FREQUENCY OF AN INPUT ANALOG SIGNAL, Ser. No. ______ of even date hereof, in which specific DSP algorithms can be implemented when the DSP clock is an integer multiple of the fundamental frequency of the input signal.

This invention relates to effects processing of a monophonic analog signal (meaning a signal whose frequency components are all integer multiples of a first fundamental frequency). For example, the signal could come from almost any musical instrument, voice included. However, for generality, the invention is not restricted to cases where the signal source is musical.

The digital signal processing is simplified as a result of the DSP being clocked at a constant multiple of f_{fund}. This means that the sine and cosine functions, as well as the low-pass filters which make up each harmonic selector, are trivial to implement because the frequencies of each sine/cosine, as well as the cutoff frequency of the low-pass filters, are each constant fractions of the DSP clock frequency.

### SUMMARY OF THE INVENTION

An input analog signal is first digitized and then processed by a DSP whose clock frequency is an integer multiple of the fundamental frequency of the analog signal. The signal is then decomposed into its individual harmonic components. Each harmonic is subjected to a selected gain or attenuation, and then the modified harmonic components are summed to reconstitute an output signal with a different harmonic profile than that of the input. The final result is converted back to an analog signal with a D/A converter.

### BRIEF DESCRIPTION OF THE DRAWINGS

The various embodiments, features and advances of the present invention will be understood more completely hereinafter as a result of a detailed description thereof in which reference will be made to the following drawings:

FIG. 1 is a block diagram of a DSP system for selective harmonic amplification and re-synthesis in accordance with the present invention;

FIG. 2 is a schematic representation of a selectively amplified n-th harmonic (A (n)) of FIG. 1; and

FIG. 3 is a schematic representation of the re-synthesis of a modified output signal of the invention.

### DETAILED DESCRIPTION OF A PREFERRED EMBODIMENT

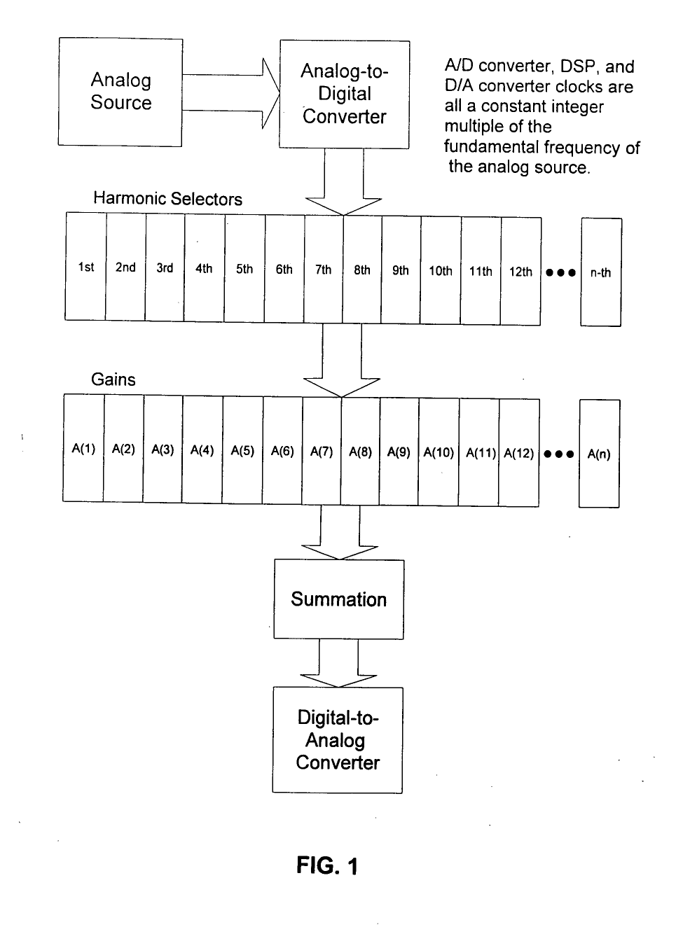

As shown in FIG. 1, an input analog signal is first digitized and then processed by a DSP whose clock frequency is an integer multiple of the fundamental frequency of the analog signal. The signal is then decomposed into its individual harmonic components. Each harmonic is subjected to a unique gain or attenuation, and then the modified harmonic components are summed to reconstitute an output signal with a different harmonic profile than that of the input. The final result is converted back to an analog signal with a D/A converter. This converted result is the “output” of the effects processor.

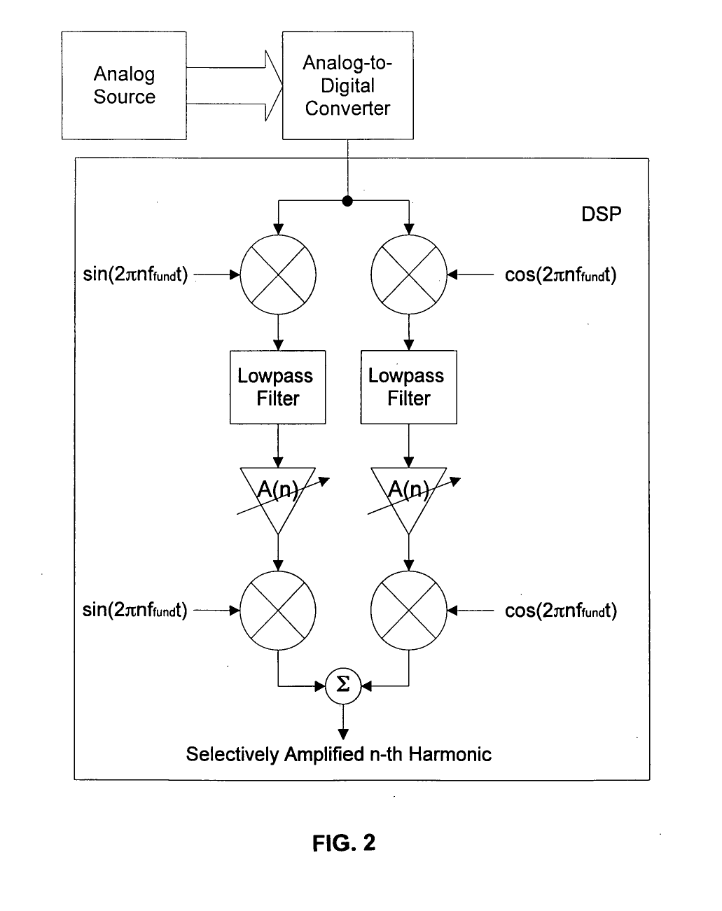

The extraction of an individual harmonic component (the “n-th” component, in this case) is shown in FIG. 2. This is done as follows: The n-th harmonic is mixed to DC in two separate paths. In the first path, the signal is multiplied by sin (2 πnf_{fund}t), where f_{fund} is the fundamental frequency of the input signal. In the second path, the signal is multiplied by cos(2 πnf_{fund}t). These two “DC” signals are passed through low-pass filters to eliminate all other frequency content and to isolate the n-th harmonic. The only restriction on the cutoff frequency of these low-pass filters is that it must be less than f_{fund} in order to ensure that no other harmonics are present at this point in the signal path. Alternatively, the filter could be a simple boxcar average of the multiplier outputs over a period corresponding to 1/f_{fund}. Such a filter, combined with the sine/cosine multipliers, can be recognized as a simple FFT. Embodiments of the harmonic selector which utilize an FFT should be considered within the scope of the present invention. Next, these two DC signals are amplified (or attenuated) by programmable amounts A(n) which can be a function of n. Next, the signal which was generated by multiplying by sin(2 πnf_{fund}t) is multiplied again by sin(2 πnf_{fund}t); the signal which was generated by multiplying by cos(2 πnf_{fund}t) is multiplied again by cos(2 πnf_{fund}t); and these two results are summed together. Simple trigonometry reveals that if A(n)=2, the original signal is reconstructed at the output with no alterations.

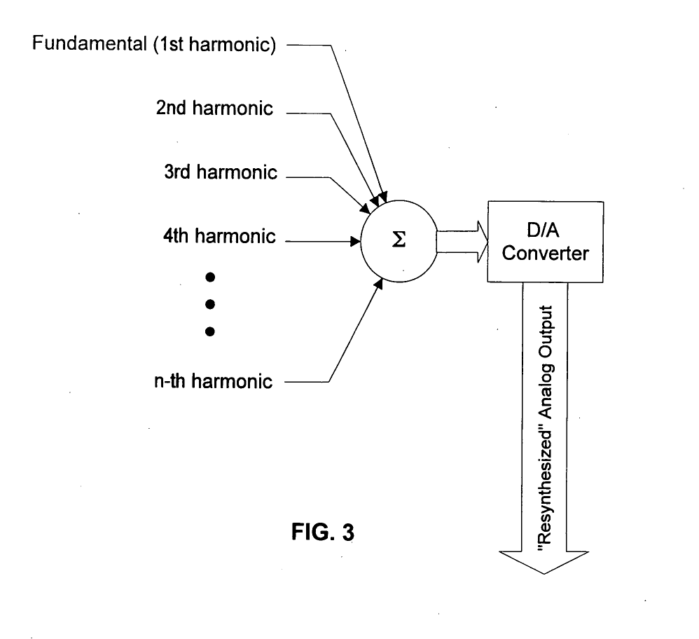

FIG. 3 illustrates the synthesis of the modified output signal. The outputs from all N harmonic “selectors” are summed together and the result is converted back into the analog domain using a D/A converter.

It cannot be sufficiently stressed how much the digital signal processing is simplified as a result of the DSP being clocked at a constant multiple of f_{fund}. This means that the sine and cosine functions, as well as the low-pass filters which make up each harmonic selector, are trivial to implement because the frequencies of each sine/cosine, as well as the cutoff frequency of the low-pass filters, are each constant fractions of the DSP clock frequency.

It is expected that creative selection of a signal source, and of the values of the A(n)'s, will yield interesting results. For example, if the input source is a human voice, and the harmonics are modified to resemble those of a violin, the output signal will have the attack and decay, in other words, the dynamics and agility/versatility of the human voice, but the harmonic timbre of a violin. It is evident that this method can be applied to transform the sound of any instrument into any other, or actually into the sound of fictitious instruments that don't actually exist in material form.

Having thus disclosed a preferred embodiment of the present invention, it will now be seen that there may be various alternative ways for carrying out the invention, as well as certain modifications that could be made to the described embodiment while still realizing the advantageous features and benefits thereof. Therefore, the scope of protection sought herein should not necessarily be deemed to be limited by the disclosed embodiment. The invention hereof should be deemed to be defined only by the appended claims and their equivalents.

I claim:

1. A music synthesizer for modifying a monophonic analog signal having a fundamental frequency; the synthesizer comprising:
an analog-to-digital converter for digitizing said monophonic analog signal;
a plurality of harmonic selectors, each such selector having a filter for passing only a selected harmonic component of said digitized analog signal;
a plurality of amplifiers respectively connected to said harmonic selectors for applying selected levels of positive or negative gain to modify each of said harmonic components;
a summing device connected to said plurality of amplifiers for combining said modified harmonic components; and
a digital-to-analog converter for re-synthesizing an analog output from said combined, modified harmonic components,
wherein each said A/D converter, selector, amplifier and summing device is synchronized by a clock signal having a frequency which is a constant integer multiple of the fundamental frequency of said monophonic analog signal.

2. The music synthesizer recited in claim 1 wherein each of said harmonic selectors comprises at least one first mixer for mixing a selected harmonic component to DC and at least one low-pass filter to block all other harmonic components.

3. The music synthesizer recited in claim 2 wherein each said low-pass filter has a cutoff frequency which is less than said fundamental frequency.

4. The music synthesizer recited in claim 2 wherein each of said harmonic selectors comprises at least one second mixer for mixing said filtered harmonic component back to its original harmonic frequency.

5. The music synthesizer recited in claim 2 wherein each said harmonic selector comprises two of said first mixers, said two first mixers each receiving a sine wave at said selected harmonic component frequency, but 90 degrees out of phase relative to each other.

6. The music synthesizer recited in claim 4 wherein each said harmonic selector comprises two of said second mixers, said two second mixers each receiving a sine wave at said selected harmonic component frequency, but 90 degrees out of phase, relative to each other.

7. The music synthesizer recited in claim 6 further comprising a summing junction receiving an output from each of said second mixers and combining them.

8. A method of modifying a monophonic analog signal having a fundamental frequency; the method comprising the steps of:
digitizing said monophonic analog signal;
splitting said digitized signal into its harmonic components;
applying a selected level of positive or negative gain to each of said harmonic components;
summing said modified harmonic components;
converting said summed components into an analog signal; and
controlling a clock signal to have a frequency which is a constant integer multiple of the fundamental frequency of said monophonic analog signal.
